(19) United States
(12) Patent Application Publication
(10) Pub. No.: US 2011/0119883 A1
(43) Pub. Date: May 26, 2011

(54) MACHINE FOR CONNECTING METAL PROFILES WITH PLASTIC STRIPS

(75) Inventors: Leon Gimelshtein, Thornhill (CA); Vinode Ramnauth, Caledon East (CA)

(73) Assignee: PRO-LINE AUTOMATION SYSTEMS LTD., Woodbridge (CA)

(21) Appl. No.: 12/953,997

(22) Filed: Nov. 24, 2010

Related U.S. Application Data
(60) Provisional application No. 61/263,876, filed on Nov. 24, 2009.

(51) Int. Cl. B23P 25/00

(52) U.S. Cl. 29/33 R

(57) ABSTRACT

A machine for connecting elongate metal profiles with plastic strips includes an elongate support table for supporting a pair of the profiles to be connected and a horizontal elongate support beam extending along one side of this table. A support carriage is mounted for movement lengthwise along the beam. There is a drive system for moving the support carriage horizontally on the beam. The machine includes top and bottom tool heads each mounted on the carriage for vertical movement thereon. The top tool head is arranged above the table and the bottom tool head below the table. Further drive systems are able to move the tool heads vertically on the carriage. Strip pullers are provided on the carriage to engage and hold end sections of two plastic strips so that they can be pulled between the two profiles. Clamping rollers are mounted on the tool heads for engaging longitudinal connecting flanges extending along the profiles in order to connect the plastic strips.

### PRIORITY APPLICATION

This application claims priority on the basis of previously filed U.S. Provisional Patent Application Ser. No. 61/263,876 filed Nov. 24, 2009.

This invention relates to machines and apparatus for connecting elongate metal profiles with plastic strips.

It is known to provide an elongate metal profiles as structural frames in the construction of buildings. However one difficulty that can arise with the use of such metal profiles on the exterior of a building is that because of their heat conducting ability, they can be a source of heat loss in a building if they are not properly insulated. One solution that has been developed in the building construction industry to prevent this source of heat loss is to use two separate elongate metal profiles to construct an exterior building frame with these two metal profiles being separated by a suitable heat insulator in the form of one or more plastic strip members. Certain common plastics are relatively good heat insulators while, at the same time they are sufficiently strong to enable strips made from the plastic material to structurally connect spaced apart metal profiles.

One known, available machine capable of assembling two elongate metal profiles by means of elongate plastic strips is made and distributed by the Belgium company, Aluro, under the trademark Aluroller. In this known machine, two elongate metal profiles are mounted on a support table in a position where they are parallel, spaced apart and positioned one above the other. One of these metal profiles is held in an elevated position by means of a series of lifting arms. The machine has two tool heads that are located beside one another and that are able to move along the profile supporting structure in a horizontal direction from one end of the structure to the opposite end and back again. During the initial pass by the tool heads, they carry out a knurling operation on the connecting flanges of the metal profiles and, at the same time, they pull two plastic strips into and along the gap formed between the two metal profiles so they are placed in position for attachment. During the return pass the machine attaches opposite edges of the plastic strips to the metal profiles by means of clamping rollers mounted on the tool heads. The combination of the two profiles and two plastic strips that have been connected together is then removed from the machine for the next assembly operation.

The present disclosure provides an improved machine for connecting together elongate metal profiles with plastic strips. According to one embodiment of this machine, only one drive system is used to move both tool heads of the machine from one end of the support beam to the opposite end and back.

### SUMMARY OF THE DISCLOSURE

According to one embodiment of the present invention, a machine for connecting elongate metal profiles with plastic strips includes an elongate support table for supporting a pair of elongate metal profiles to be connected. This table forms a table top having an elongate slot extending longitudinally along the table top, The table top is divided by the slot into an inner top section for supporting an elongate first metal profile and an outer top section for supporting an elongate second metal profile so that, during use of the machine, the first and second metal profiles are horizontally spaced from one another. The machine further includes a horizontal, elongate support beam extending along one side of the support table. A support carriage is mounted for horizontal movement lengthwise along the beam and a first drive system is provided for moving the support carriage horizontally along the beam in a front end to rear end direction to pull two plastic strips between the first and second profiles and in a rear end to front end direction to clamp opposite edges of each plastic strip respectively to the first and second profiles. The machine further includes top and bottom tool heads each mounted on the support carriage fro vertical movement thereon. The top tool head is mounted above the support table and above the bottom tool head while the bottom tool head is mounted below the support table. There are two further drive systems for respectively moving the tool heads vertically on the support carriage. A strip puller mechanism is mounted on the tool heads for horizontal movement therewith and this strip puller mechanism is adapted to engage and hold end sections of the two plastic strips prior to and during the pulling of the strips between the first and second profiles. A pair of clamping rollers is rotatably mounted on each tool head for respectively engaging and bending longitudinal connecting flanges extending along the lengths of the first and second profiles in order to connect the two plastic strips to these profiles.

In an exemplary version of this machine, at least one rotatable knurling tool is mounted on each tool head so as to be vertically movable on its respective tool head. This machine is adapted to carry out a knurling operation on longitudinal connecting flanges as the two plastic strips are pulled between the first and second profiles.

According to another embodiment of the invention, a machine for knurling and connecting elongate, first and second metal profiles comprises an elongate support table for supporting and holding the first and second metal profiles so that they are spaced apart from one another a predetermined distance; a horizontal, elongate support member extending along the support table in its lengthwise direction; a single support carriage mounted for movement along the length of the support member; a tool head system mounted on the support carriage for vertical movement thereon; a motor drive for moving the support carriage horizontally along the support member in the lengthwise direction; a drive system for moving the tool head system vertically; clamping rollers rotatably mounted on the tool head system for respectively engaging and bending longitudinal connecting flanges extending along the lengths of the first and second profiles in order to connect same by plastic connecting strips inserted between the profiles; and rotatable knurling tools mounted on the tool head system so as to be vertically movable relative to the tool head system and adapted to carry out a knurling operation on the longitudinal connecting flanges prior to the bending of the longitudinal connecting flanges by the clamping rollers.

According to still another embodiment of the invention, a machine for connecting elongate, first and second metal profiles with plastic strips comprises an elongate support table arrangement for supporting and holding the first and second metal profiles in fixed, spaced-apart positions; a support carriage system including a support carriage mounted for powered movement lengthwise along the support table arrangement; a tool head system mounted on the support carriage for vertical movement thereon; a linear drive system for moving the tool head system vertically; clamping rollers rotatably mounted on the tool head system for respectively engaging and bending longitudinal connecting flanges extending along the lengths of the first and second profiles in order to connect same by clamping each longitudinal edge of each plastic strip between a respective pair of the connecting flanges; and at least one pulling mechanism mounted on the tool head system for horizontal movement therewith, the at least one pulling mechanism including at least one power drill adapted to hold and turn a drill bit, wherein, during use of the machine, the at least one power drill fitted with the drill bit can drill through and hold at least one end section of at least one plastic strip in order to pull the at least one plastic strip between the first and second profiles.

Further features and advantage will become apparent from the following detailed description taken in conjunction with the accompanying drawings.

### BRIEF DESCRIPTION OF THE DRAWINGS

FIG. 1 is an end view of a machine for connecting elongate metal profiles with plastic strips, portions of the machine being shown in cross-section, this cross-section being taken along the line I-I of FIG. 2A;

FIG. 2A is a side elevation of a right hand end portion of the machine of FIG. 1;

FIG. 2B is a side elevation of a central portion of the machine of FIG. 1;

FIG. 2C is a side elevation of a left hand or rear end portion of the machine of FIG. 1;

FIG. 3A is a top view of the right hand or front end portion of the machine;

FIG. 3B is a plan view of the central portion of the machine of FIG. 1;

FIG. 3C is a plan view of the left hand end portion of the machine;

FIG. 4 is a side elevation of a top tool head used in the machine of FIG. 1;

FIG. 5 is a plan view of the top tool head;

FIG. 6 is an end view of the top tool head, this view being taken from the right hand end of the machine;

FIG. 7 is an elevational detail view showing a high speed drill of the machine and its mounting arrangement, this view being partially in cross-section along the line VII-VII of FIG. 4;

FIG. 8 is a side elevation of a bottom tool head used in the machine of FIG. 1;

FIG. 9 is a plan view of the bottom tool head of FIG. 8 with a servo motor shown on the left side of both FIGS. 8 and 9 having a central portion cut away for ease of illustration;

FIG. 10 is an end view of a detail of the machine of FIG. 8, this view omitting a knurling tool assembly mounted on the head for ease of illustration;

FIG. 11 is an elevational detail showing a high speed drill and the mounting arrangement therefor, this view being partially in cross-section along the XI-XI of FIG. 8;

FIG. 12 is a cross-sectional detail taken along the line XII-XII of FIG. 2A;

FIG. 13 is a plan view of a guide assembly for the two metal profiles connected by the machine of FIG. 1;

FIG. 14 is a side elevation of the guide assembly of FIG. 13, this view showing a clamping roller of the machine in chain link lines;

FIG. 15 is a cross-sectional detail of part of a guide assembly, this view being taken along the line XV-XV of FIG. 13;

FIG. 16 is a vertical cross-section of the support table and the slot formed therein, this view also showing a partial end view of the guide assembly of FIG. 13;

FIG. 17 is a detail elevational view illustrating how each ball screw drive of the machine can be spring loaded;

FIG. 18 is an end view of one knurling tool showing its knurling wheel carrying out a knurling operation on one of the profiles;

FIG. 19 is a detail top view of the knurling wheel illustrating its imprinting teeth;

FIG. 20 is a detail view of the encircled area A of FIG. 19;

FIG. 21 is a top view of end fixtures used to hold the profiles at their two ends;

FIG. 22 is an end view of two end fixtures with profiles mounted thereon; and

FIG. 23 is a cross-sectional elevation of another form of movable mount for the inner table top.

### DETAILED DESCRIPTION OF EXEMPLARY EMBODIMENTS

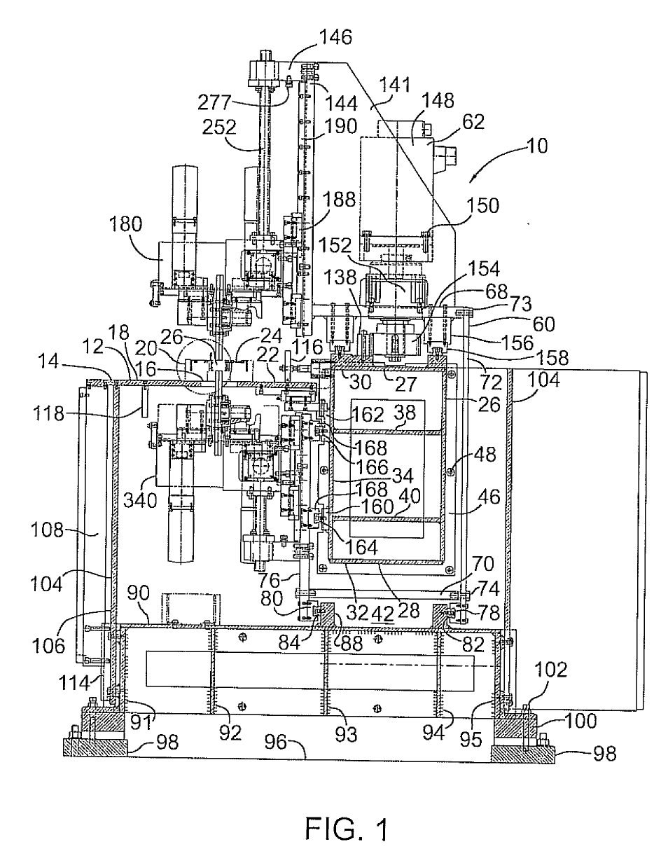

FIGS. 1 to 3C illustrate an embodiment of a machine 10 for connecting elongate metal profiles with plastic strips, normally two plastic strips. The machine includes an elongate support table 12 for supporting a pair of elongate metal profiles to be connected, The table forms a table top 14 which can be made of a suitable metal and an elongate slot 16 extends longitudinally along the table top. Thus the table top is divided by the slot into an outer top section 18 for holding one of the two metal profiles, such as the metal profile 20 shown in FIG. 1, and an inner top section 22 for supporting another or second metal profile, such as the profile 24 shown in FIG. 1. As can be seen from FIG. 1, during use of the machine 10, the first and second metal profiles are horizontally spaced from one another and form a gap 26. It will be seen that this gap is located directly above the slot 16 and it is located between the clamping rollers of the machine described hereinafter.

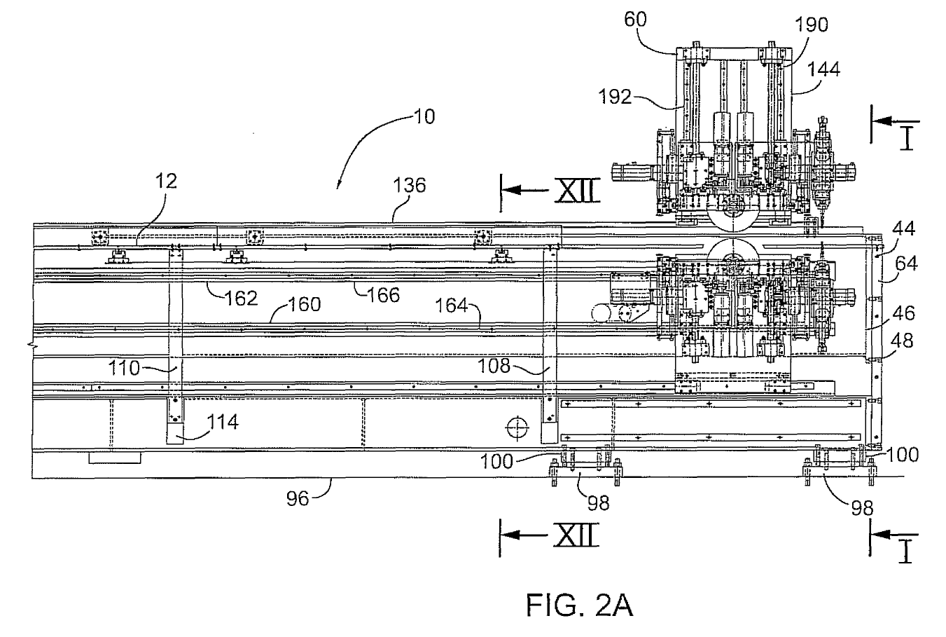

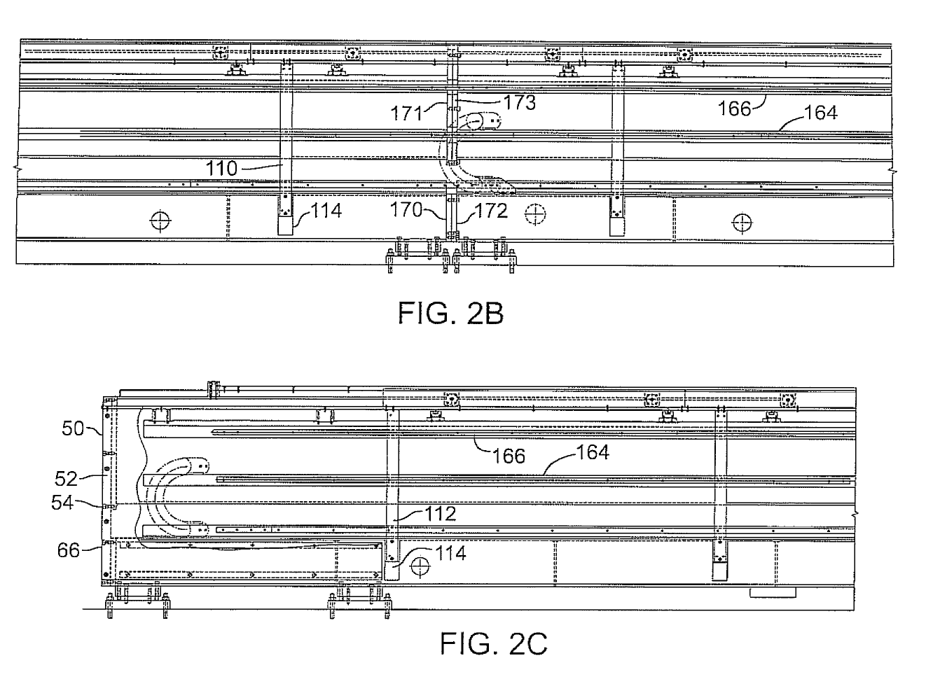

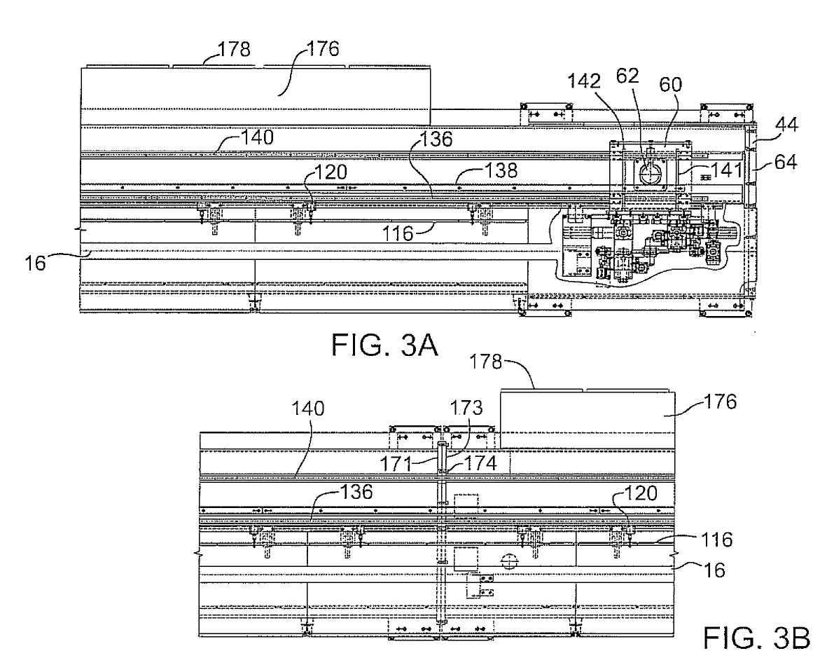

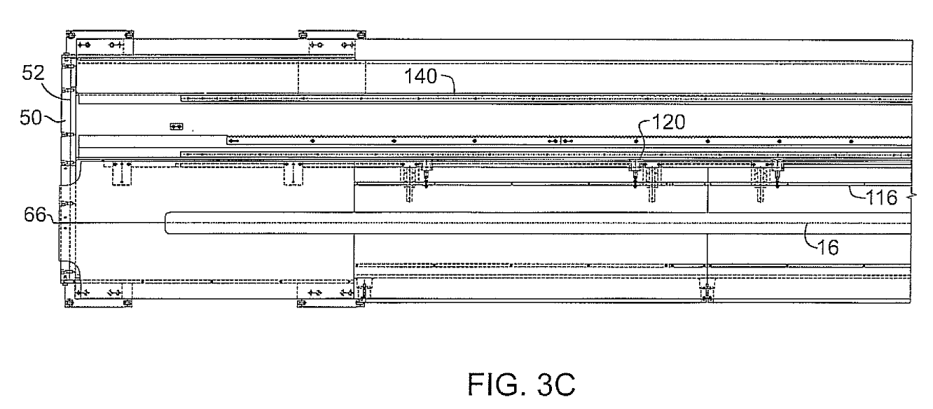

In addition to the support table, the machine includes a horizontal, elongate support beam indicated generally at 26. The beam extends along one side of the support table and has a top 27 and a bottom 28. The beam, which extends substantially the length of the machine can have a rectangular transverse cross-section as shown in FIG. 1 formed by a flat top plate 30, flat bottom plate 32 and two, elongate opposite side plates 34 and 36. In order to strengthen the rigidity of the beam, it can be formed with horizontal intermediate walls 38 and 40. The beam is supported at its opposite ends by means of end supports so that the beam is in an elevated position and a space 42 is formed below the bottom of the beam for reasons to be described. Shown in FIGS. 2A and 3A is a beam mounting plate 44 and the adjacent end of the beam is connected to this plate by means of a U-shaped holding bracket 46 which is welded to the bottom and sides of the beam and its attached to the plate 44 by means of six bolts 48. The opposite end of the beam is similarly mounted to a vertical plate 50 shown in FIGS. 2C and 3C. A beam-holding bracket 52 is attached by bolts 54 to the plate 50.

A support carriage 60 is mounted for horizontal movement lengthwise along the support beam and a first drive system indicated generally at 62 is provided for moving the support carriage horizontally along the support beam. firstly in a front end (indicated at 64) to a rear end direction (the rear end being indicated at 66 and shown in FIGS. 2C and 3C) to pull two plastic strips between the two metal profiles and secondly in a rear end to front end direction to clamp opposite edges of each plastic strip respectively to the two metal profiles. With reference to FIG. 1, the illustrated exemplary carriage includes a top section 68 extending over a top of the beam and supported thereon, a bottom section 70 extending across a bottom of the beam and a vertical side section 72 extending downwardly across one side of the beam and rigidly connecting the top and bottom sections of the carriage. The top and bottom sections can be bolted at 73 and 74 to the side section. The carriage can also include a second side section 76 comprising a vertically extending plate located on the side of the beam opposite the side section 72 and also bolted to the bottom section of the carriage. Mounted on a bottom edge section of each of the side sections 72, 76 are rail mounted blocks 78, 80 respectively. These blocks are slidable along elongate rails 82 and 84 which are mounted on elongate rails supports 88 that can be welded to horizontal support plate 90. However, in one version of the present machine, the blocks 78, 80, the rails 82, 84 and the rail supports 88 are omitted as they are unnecessary to support the carriage and the two tool heads. The plate 90 together with short vertical support plates 91 to 95 form a platform that can support the machine on a suitable floor indicated at 96. The platform can be detachably connected to a series of spaced apart floor plates 98 located on both sides of the machine. A series of feet 100 can be arranged along the support platform and can be attached to the floor plates by screws 102. Extending upwardly from one side of the support platform is a protective cover plate 104 that extends to the level of the top of the beam. Mounted on the opposite side of the support platform is another side cover plate 106 which supports the table top 14. Extending along the length of the machine are a series of spaced apart vertical pillars including a front pillar 108 shown in FIG. 1, four middle pillars 110 which can be seen in FIGS. 2A to 2C and a rear pillar 112. These pillars are attached to the outer top section 18 of the table top by suitable screws and support the outer top section. The bottom ends of the pillars are mounted by means of threaded fasteners to vertical support blocks 114 which are mounted to the side of the support platform. The inner top section 22 of the table is supported by means of a movable, elongate stiffener bar 116. The outer top section 18 is made more rigid by outer stiffener bar 118, the latter extending longitudinally below the outer top section 18. The inner stiffener bar 116 is located on top of the inner top section 22 and the position of this bar and the inner top section 22 is horizontally adjustable by means of a series of spaced apart air cylinders 120. As illustrated there are 10 of these cylinders which move in unison to move the bar 116 and the inner top section so that the width of the slot 16 is adjustable.

With reference to FIG. 12 which illustrates details of the mounting for the inner top section 22, mounted below the inner top section 22 are a series of spaced apart, short rails 122 which extend transversely of the top section 22. These rails can be attached by screws and mounted on each rail is a block 124 mounted on a bracket member 126. This bracket member is rigidly connected to the adjacent side of the beam. A spacer 128 can be provided between the horizontal top surface of the bracket and the block. The piston of each air cylinder 120 can be connected to the stiffener bar by means of two jam nuts 130 and a set screw 132. Also shown in FIG. 12 is a top supporting bar 134 which is welded on top of the beam and supports longitudinal rail 136 as well as a long rack 138. The rail 136 and a second rail 140 (see FIGS. 3A to 3B) provide support for the carriage 60 at the top of the beam as well as means for the carriage to move along the beam.

Further details of the construction of the exemplary support carriage 60 and its drive system will now be described with reference to FIGS. 1 to 3C. Mounted on top of the top section 68 of the carriage are two vertical support plates 141, 142. Each of these plates is rigidly attached to a vertical support plate 144 which can extend below the top section 68 a short distance. Attachably mounted to the top end of the plate 144 by means of screws, is a ball nut mounting bracket 146. Mounted between the two plates 141, 142 is a relatively large servomotor 148 which is the drive motor for moving the carriage along the beam. A suitable servomotor is that sold by Mitsubishi Model HC-SFS702 which can operate at 2000 rpm and requires 7 KW power. This servomotor can be attached by four screws 150 to a gearbox 152 which in turn can be connected by four screws to the top section 68 of the carriage. The gearbox can be provided with a mounting flange for the motor. One suitable gearbox is that sold by Apex, Model AF140-S2. The output shaft of the gearbox is connected to a spur gear 154, the teeth of which engage the aforementioned rack 138 mounted on top of the beam. The spur gear is mounted on the end of the output shaft by means of a suitable washer and screw as shown in FIG. 1. To provide room for the spur gear and rack, two spacers 156 are welded to the bottom side of the top section 68 and mounted by means of screws on each of the spacers are two, spaced apart blocks 158, both of which are visible in FIG. 2A. These blocks engage their respective rails 136, 140 extending along the top of the beam. It will thus be seen that the support carriage is slidably mounted for movement along the length of the beam. Further support for the carriage is provided at the side of the beam facing towards the support table. In particular mounted on this side are upper and lower horizontally extending rail supporting strips 160 and 162 which can be welded in place. Attachably mounted on these strips are horizontally extending rails 164, 166 and mounted on each of these rails are a pair of carriage supporting blocks 168

It will be seen from FIGS. 2B and 3B that the support table 12 in the exemplary machine is divisable into two sections at the longitudinal middle for ease of transport and storage. In particular near the longitudinal centre of the machine there can be provided vertically extending connecting plates 170 to 173 which can be joined together by screws 174. Also visible in FIGS. 3A and 3B is a metal storage cabinet 176 having vertical doors 178. This cabinet can be used to store the control equipment for the machine including a suitable personal computer programmed to operate the machine in the manner described hereinafter.

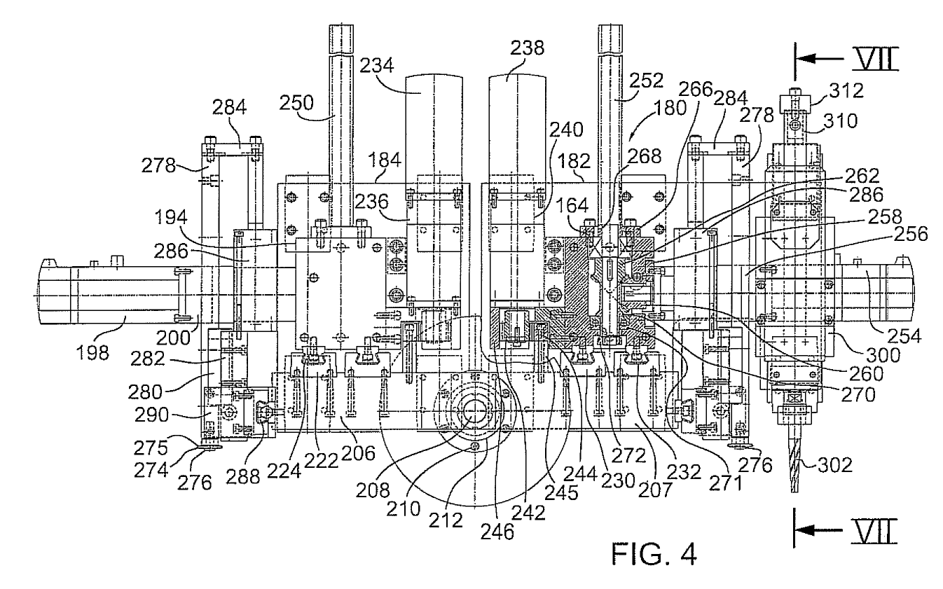

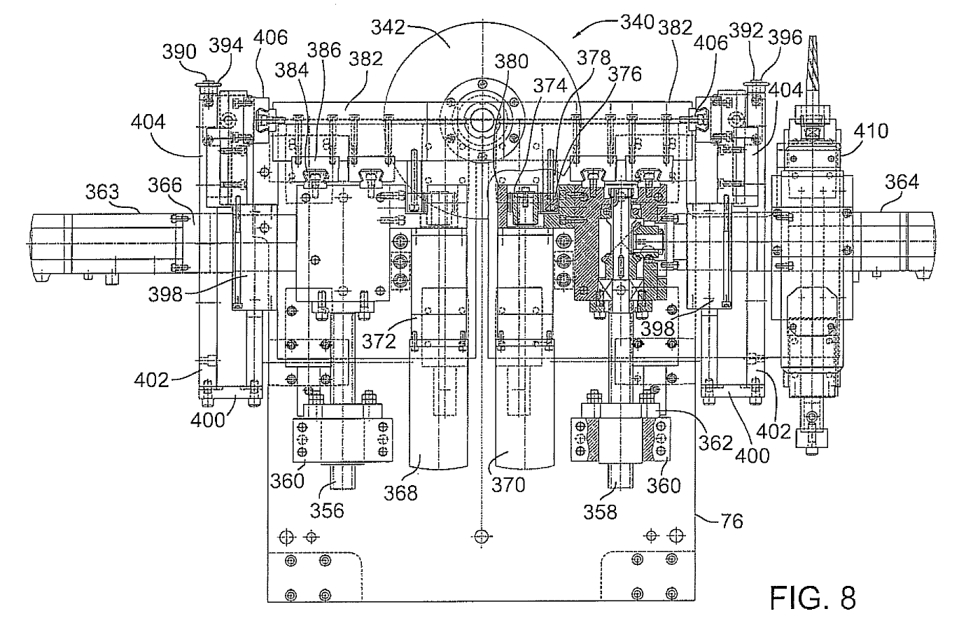

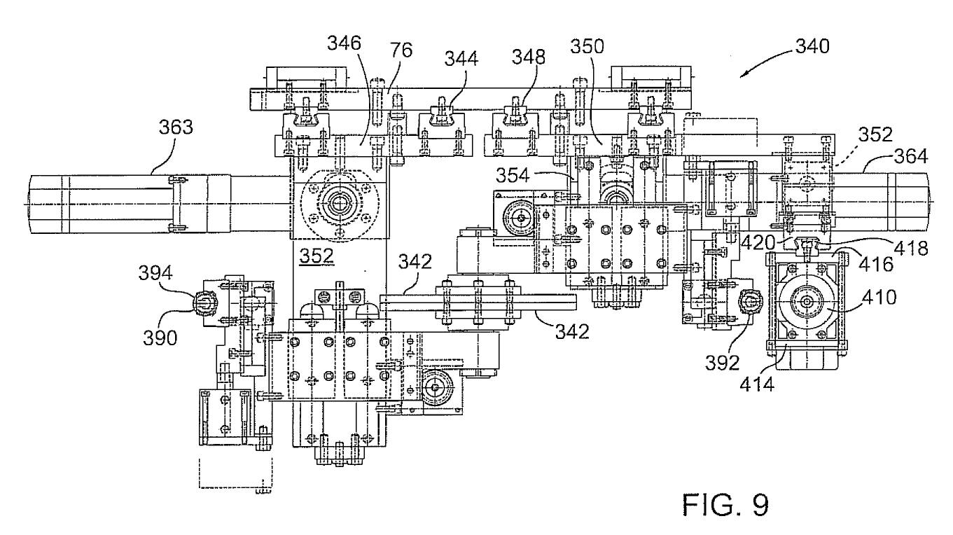

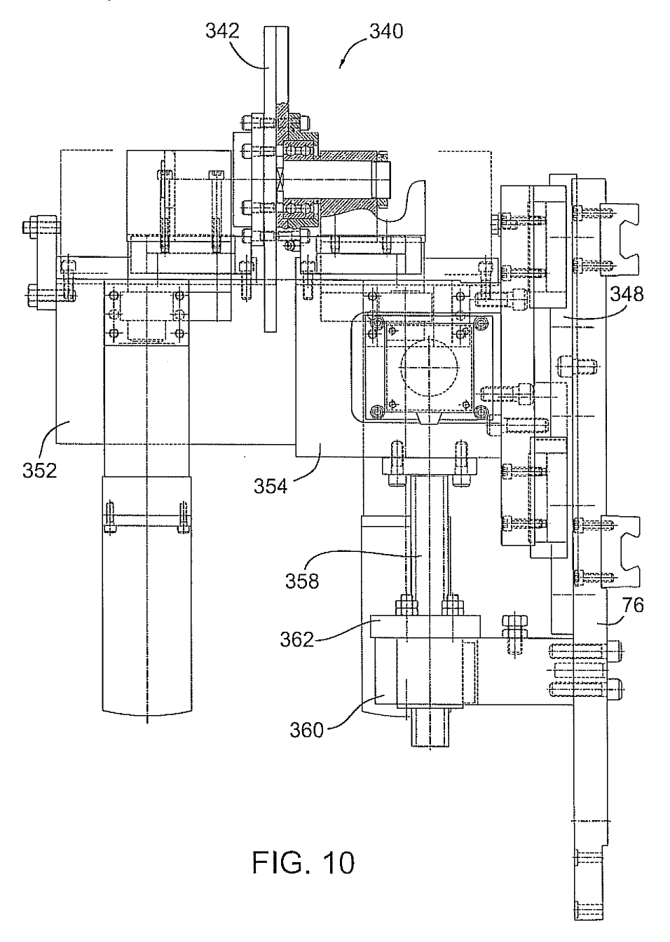

Both a top tool head and a bottom tool head are mounted on the support carriage 60. An embodiment of a top tool head is illustrated in detail in FIGS. 4 to 7 and a bottom tool head is illustrated in detail in FIGS. 8 to 11. With reference first to the top tool head 180, this tool head is provided with its own drive system for moving the tool head vertically on the support carriage. The tool head can include a right hand mounting plate 182 and a left hand mounting plate 184, these two plates extending vertically in the same plane. Mounted on the mounting plate 184, are four rail engaging blocks 186 attached to the plate by means of screws. Attached to the right hand mounting plate 182 are an additional four rail mounting blocks 188. The blocks 188 are mounted on two vertical rails 190, one of which can be seen in FIG. 1. These rails are detachably connected by screws to the support plate 144 of the carriage. Similarly the blocks 186 are mounted on two spaced apart vertical rails 192 visible in FIG. 2A. In one embodiment of the top tool head, the right hand and left hand plates 182, 184 are rigidly connected together by a mounting bracket extending across the gap between the plates.

Mounted on the plate 184 is a first gear housing 194 which is detachably connected to the plate by means of screws. Similarly mounted on the plate 182 is a second gear housing 196. Extending from one side of the first gear housing is a servomotor 198 which is equipped with a brake. A suitable servomotor is that sold by Mitsubishi, Model HC-KFE43KB. This servomotor can be connected by four screws to a gearbox 200. A suitable gearbox is that sold by Gearmax, Model 23GM028. This servomotor operates one of two ball screw drivers as explained later below. However, in another version of the machine, there is only one ball screw driver on the top head and the servomotor 198 can be omitted.

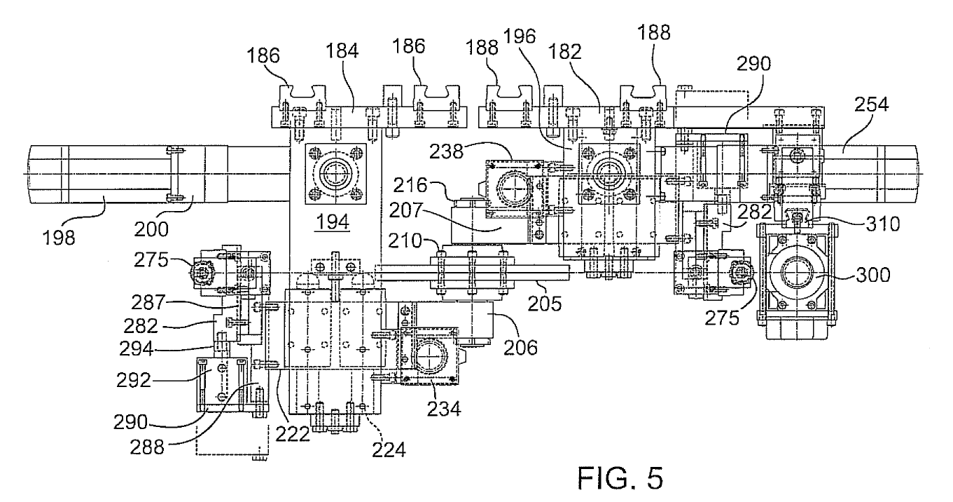

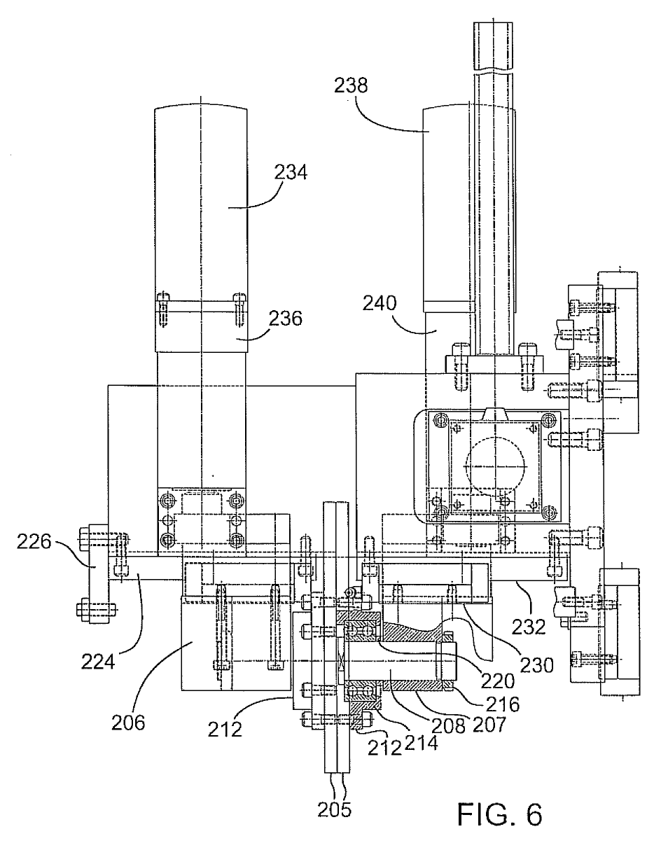

Mounted on the two gear housings 194, 196 are a pair of clamping rollers 205. These rollers are mounted between two roller mounting brackets 206 and 207 visible in FIG. 5. The bracket 206 is connected to the gear housing 194 while the bracket 207 is connected to the gear housing 196. Each clamping roller can be secured on a horizontal shaft 208 by means of six screws 210. These screws extend through an annular flange formed on each of two bearing housings 212. Rotatably supporting each roller is a pair of angular contact ball bearings 214 mounted in the housing 212. The shaft or bearing axle 208 is secured at each end by a lock nut 216. As shown in FIG. 6, between the bearings 214 and their respective mounting bracket is a bearing spacer 220. The position of each clamping roller can be adjusted horizontally in order to properly position the roller for engagement with a connecting flange formed on its respective metal profile. With respect to roller mounting bracket 206, detachably mounted thereon are two rail gripping blocks 222 which are respectively slidable on transversely extending rails 224. At the outer end of the rails there can be detachably connected a stop bracket 226. In a similar manner the other mounting bracket 207 for the other clamping roller has two rail holding blocks 230 mounted on its top and these grip two parallel, transversely extending rails 232. The rails 224 are detachably mounted on the bottom of the first gear housing 194 while the rails 232 are mounted on the second housing 196.

The roller mounting bracket 206 can be adjusted horizontally by means of an upwardly extending servomotor 234 which is connected to a gearbox 236 by means of four screws. The other roller mounting bracket 207 is horizontally movable together with its clamping roller by means of another servomotor 238 which is mounted by screws on tops of its own gearbox 240. As illustrated in cross-section below the gearbox 240, the output shaft of the gearbox turns a spur gear 242 held in place by a screw that holds a spacer washer against the end of the gear. This spur gear engages a rack 244 on one side. The rack is mounted on a rack spacer 245. Each of the gearboxes 236, 240 is mounted on a bracket 246 which is attached by screws and pull-dowels to the adjacent gear housing 194, 196. The pull-dowels used here and elsewhere in the machine are hollow dowels with ¼ inch of threads internally at one or both ends. The threads allow the dowel to be moved or pulled out when required. It will be seen that the rotation of the spur gear causes inward or outward movement of the rack which in turn causes inward or outward movement of the respective roller mounting bracket to which the rack spacer is connected.

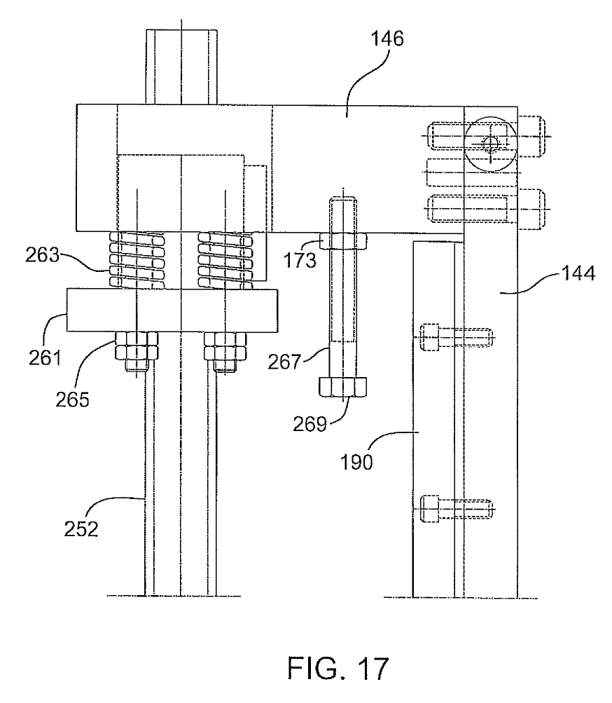

The top tool head can be raised or lowered on the support carriage by means of one or two ball screws which extend vertically and which can be of standard construction or spring loaded as explained hereinafter in conjunction with FIG. 17. The illustrated top head has two ball screws 250 and 252. In an alternate version using only one ball screw, the left side ball screw 250 is omitted. The ball screw 250 is powered by means of the aforementioned servomotor 198 and the attached gearbox 200. The ball screw 252 is powered by means of a further servomotor 254 located at the opposite end of the tool head and extending horizontally towards the front end. The servomotor 254 is connected by screws to its own gearbox 256. The gearbox is connected to a gearbox mounting plate 258 by means of four screws. The output shaft of the gearbox turns a spiral mitre gear 260 which engages and turns a further spiral mitre gear 262 non-rotatably attached to the ball screw. Mounted above this gear is an angular contact ball bearing 264 which is held in place by a bearing cover 266. A spacer can be provided at 268 around the ball screw. Mounted on the bottom section of the ball screw is a bearing spacer 270 which engages the bottom end of the mitre gear 262. The flange on this spacer engages the top of a thrust ball bearing 271. A lock nut 272 can be mounted on the bottom end of the ball screw. The two ball screws on the top tool head operate in a similar manner and operate simultaneously to move the tool head upwardly or downwardly as required relative to the carriage. In the version of the top tool head having only the ball screw 252 on the right, the servomotor 254 can extend vertically and be positioned to the right of the ball screw (as viewed in FIG. 4). In this embodiment, a right angle gear box is attached to the bottom end of the servomotor. Such a gear box can be obtained from Carson Mfg., Model 23RE010.

FIG. 17 illustrates an exemplary mounting arrangement for each of the upper ball screws 250, 252 with only the ball screw 252 being illustrated. In a well known manner the ball nut 261 is rotatably mounted on the ball screw and is resiliently mounted on the ball screw and is resiliently held in position by short coil springs 263 extending between the top of the ball nut and the bottom of the mounting bracket 146. An elongate stud extends downwardly through each coil spring and through a respective hole in the ball nut. Two jam nuts 265 are threaded onto each stud to securely hold the ball nut on the studs. Preferably there are four coil springs 263 evenly distributed around the ball screw. It will be appreciated that the coil springs 263 act to bias the ball nut and its ball screw 252 downwardly. Thus the clamping rollers are biased by the springs into engagement with their respective connecting flanges on the two metal profiles. However as there can be some slight variations in the location and size of each connecting flange, the springs allow for this variation and allow the rollers to move slightly upwardly as required during the rolling/clamping operation of the machine 10. Also shown in FIG. 17 is an adjustable stop member 267 which acts to limit the upward movement of the top tool head. The stop member comprises a hex screw 269 i.e. ⅜^{th} inch, and an adjustable nut 273. If no coil springs 263 are provided (as in the embodiment of FIG. 1) a shorter hex screw 277 can be used.

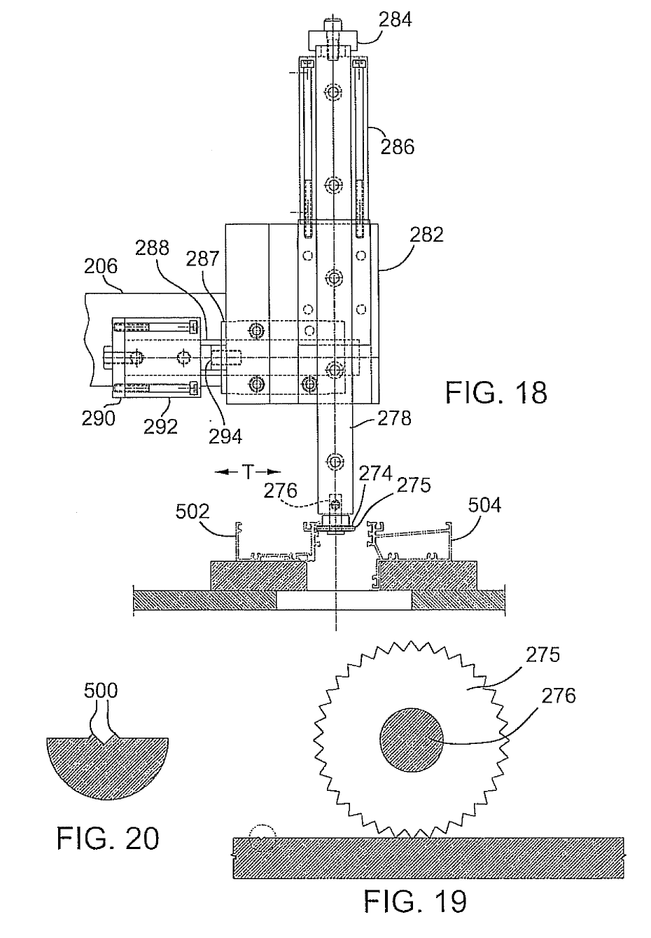

Mounted at each end of the top tool head is a rotatable knurling tool which is vertically movable relative to the tool head. The exemplary machine 10 is adapted to carry out a knurling operation on the longitudinal connecting flanges of the two metal profiles as two plastic strips are pulled between these profiles. A first knurling tool 274 is mounted on the forward end of the tool head while a second knurling 276 is mounted at the rearward end. Each knurling tool has a generally circular knurling wheel 275 which is mounted on a vertically extending shaft 276. In an exemplary form of the knurling wheel, it is constructed to imprint the connecting flange of the metal profile with knurls 500 in a non-cutting manner as shown in FIGS. 19 and 20. Not only can the knurling tool be moved vertically on its tool head but it is also movable horizontally in a direction transverse to the length of the metal profiles 502, 504 shown in FIG. 18. This horizontal or cross motion is indicated by the arrow T. The knurling tool is mounted at the bottom end of the vertical rail 278 which has a ¼ inch hole in its bottom end to receive the shaft 276, and the rail 278 is movable in a rail embracing block 280. The block is secured to an upright support member 282. The upper end of the rail is detachably connected to a push-pull bracket 284 which is moved upwardly or downwardly by means of an air cylinder 286 (see FIG. 4). The air cylinder is detachably connected to the top of the support member 282. The support member 282 or block is connected by screws to a rail receiving block 287 which is movable on a horizontal rail 288. The side of this rail is connected by screws to the roller mounting bracket 206 or 207. Connected to one end of the rail is an air cylinder mounting bracket 290 and mounted on this bracket is an additional air cylinder provided to move the adjacent knurling tool horizontally and to apply tne necessary pressure to the knurling wheel 275. This cylinder 292 has its piston rod 294 connected to the support member 282. The knurling tool can accommodate tolerances both in the vertical and horizontal directions in the size of the metal profile (usually an aluminum part) which can vary slightly between the profiles to be joined. The shaft 276 is held in its hole in rail 278 by a set screw 279. In mounting the shaft in its hole a shim (not shown) is used to provide a clearance, which can be about 40/1000ths of an inch between the top side of the knurling wheel 275 and the bottom end of the rail 278. After the shim is removed, the wheel is able to move vertically relative to the rail up to 40/1000ths of an inch to accommodate the aforementioned tolerance in the vertical direction. As for horizontal tolerance, it will be appreciated that the horizontal position of each knurling tool is determined to a degree by the pressure exerted by the respective knurling tool on the pair of longitudinal connecting flanges engaged thereby during the knurling operation. Thus the air pressure actuator 292 allows a small amount of movement of the knurling wheel to accommodate tolerances.

In addition to the knurling tools and the clamping rollers, the exemplary top tool head is provided with a high speed drill indicated generally at 300. The high speed drill provides an exemplary strip puller which is mounted on the carriage for horizontal movement therewith. This strip puller is adapted to engage and hold an end section of one of the two plastic strips prior to and during the pulling of the plastic strip between the two metal profiles. It will be understood that each of the high speed drills (one on each of the two tool heads) drills through an adjacent end section of a respective one of the plastic strips in order to engage and hold the plastic strip for the pulling operation. As an alternative, it is possible to provide only one high speed drill to drill through and pull both of the plastic strips.

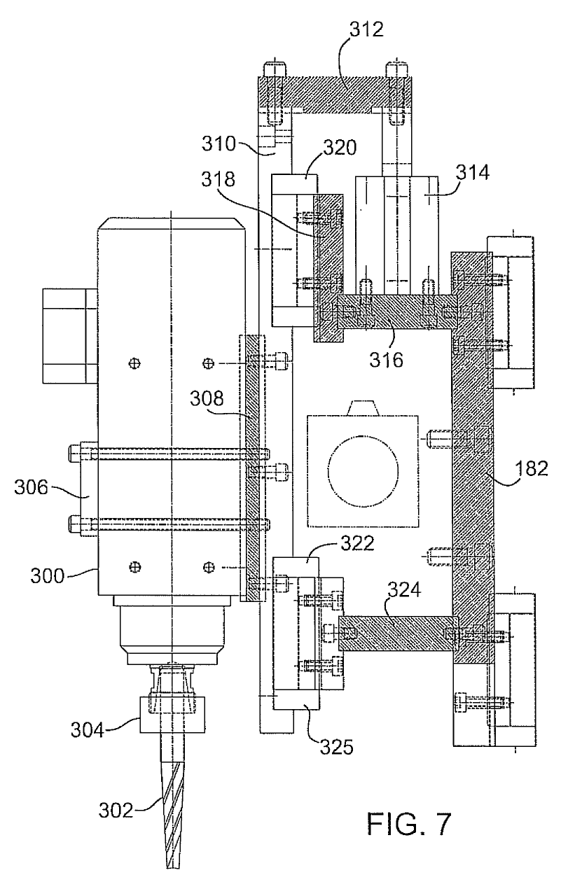

Reference will now be made to FIG. 7 which illustrates the upper high speed drill 300 and its mounting arrangement on the top tool head. The exemplary drill bit shown is a tapered end mill bit available from KBC Tools, Model No. 1-322-KK409. This drill bit 302 is mounted by means of a nut 304 that turns on a collet which can have an internal diameter of 1½ inch. The drill motor and collet are available, for example from Teknomotor, Model 31/40-C DBS-ER20. This motor has a horsepower of 0.73 and is capable of drilling at 12,000 rpm. The motor is mounted by means of a motor clamp 306 which is attached by four long screws to motor mounting plate 308. This plate is attached by screws to vertically extending rail 310. The rail extends up to a push-pull bracket 312 which is connected to the piston rod of air cylinder 314. The air cylinder is mounted by means of screws to a cylinder mounting plate 316. Connected to one edge of this plate is the right hand mounting plate 182 and connected to the opposite edge of the plate is a block mounting plate 318, on which is mounted the rail receiving block 320. The rail 310 is movable vertically in the block 320 as well as in a second rail receiving block 322. The block 322 is detachably connected to block mounting bracket 324 which is connected by screws to the plate 182. It will thus be seen that the high speed drill is movable vertically relative to the plate 182 by means of the air cylinder 314. One suitable air cylinder for this purpose is an SMC actuator, Model NCDQ2A32X200DC. In an alternate drill mount, the motor mounting plate is connected to both an elongate mounting bar that extends up to the bracket 312 and a single rail receiving block that is slidably mounted on a vertical rail. This rail is then rigidly connected by screws to vertical plate 318 and to the lower vertical plate 325.

The machine 10 also includes a bottom tool head which is illustrated in FIGS. 8 to 10. The bottom tool head 340 has many features and components similar to those described above in connection with the top tool head. The bottom tool head carries out operations for the connection of two elongate metal profiles with plastic strips similar to those carried out by the top tool head. Accordingly the following description is directed to the differences in the construction of the two tool heads on the machine. The tool head 340 is mounted for vertical movement on the support carriage 60 and there is a drive system in the form of either one ball screw drive or two ball screw drives for moving the bottom tool head vertically on the support carriage. The illustrated version has two ball screw drives. A pair of clamping rollers 342 are rotatably mounted on the bottom tool head at its upper side. These rollers can engage and bend longitudinal flanges extending along the lengths of the two metal profiles in order to connect two plastic strips to these profiles and it.will be understood that they work in cooperation with the clamping rollers mounted on the top tool head. As can be seen from FIGS. 1 and 2A, the rollers 342 are mounted directly below the rollers on the top tool head.

Mounted on a pair of vertically extending rails 344 is a left hand mounting plate 346. Also, mounted on an additional pair of rails 348 is a right hand mounting plate 350. The rails are mounted on the plate forming side section 76 of the support carriage. Mounted on the left hand mounting plate is a left hand gear housing 352 while mounted on the right hand mounting plate is the right hand gear housing 354. Extending downwardly from these two gear housings are two, parallel ball screws 356 and 358. The bottom end section of each ball screw is detachably connected to the plate 76 by means of a ball nut mounting bracket 360. Mounted on top of this bracket is a ball nut 362. The two ball screws can be rotated simultaneously and in unison by their respective servomotors, 363, 364, each of which is operably connected to its own gearbox 366. In an alternate version of the bottom tool head, only a single ball screw 358 is used and the ball screw 356 and its servomotor 363 can be omitted. In this version, the left and right mounting plates 346, 350 are rigidly connected to each other for simultaneous movement.

Positioned centrally on the bottom tool head are two additional servomotors 368, 370, each of which is provided with its own gearbox 372 located above the motor. The output of each gearbox is connected to and is able to rotate a spur gear 374, one of which is shown in vertical cross-section. The spur gear engages a respective rack 376 which is mounted at the bottom end of a rack spacer 378. Each gearbox 372 is supported at its top end by means of a gearbox mounting bracket 380. It will be understood that the servomotors 368, 370 and their respective spur gears and racks enable the horizontal position of each lower clamping roller to be adjusted so that they can be moved towards or away from each other. This is possible because each of the roller mounting brackets 382 is mounted on a pair of rails 384, These rails are held in blocks 386 detachably connected to each mounting bracket.

Two knurling tools are also mounted on the bottom tool head and each is vertically movable on the tool head. These knurling tools also serve to carry out a knurling operation on the longitudinal connecting flanges of the metal profiles as the plastic strips are pulled between the two profiles. A leading knurling tool is indicated at 390 and a trailing knurling tool is indicated at 392. Each of these knurling tools has a knurling wheel 394 which is mounted on a vertical shaft 396. Again, in an exemplary version of the knurling tool, it is able to imprint the connecting flange rollably engaged by the wheel with knurls in a non-cutting manner, The result of the knurling operation is that the flange is better able to hold the attached plastic strip. Each knurling tool is able to be raised or lowered in its position by means of an air cylinder 398 which is connected to a push-pull bracket 400. The bracket is connected to an elongate rail 402 which can move up and down in a rail holding block 404. In a manner already explained in connection with the knurling tools mounted on the top tool head, the lower knurling tools are also adjustable horizontally by means of horizontal rails 406. These rails are each mounted to the end of the adjacent roller mounting bracket. In a manner similar to the upper knurling tools, each of the tools 390, 392 can accommodate tolerances both in the vertical direction and in the horizontal direction.

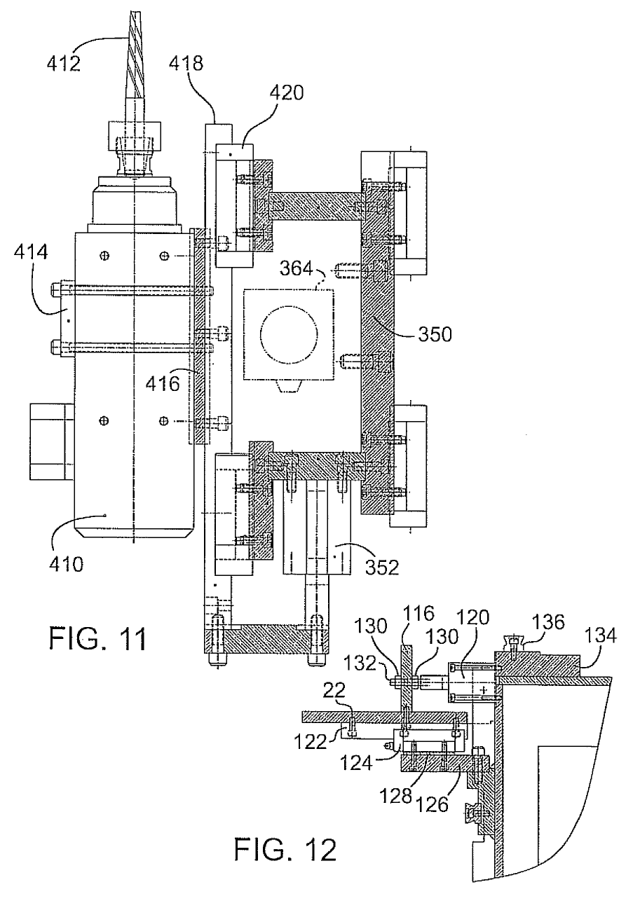

There is also mounted on the bottom tool head a high speed drill indicated generally at 410, The details of the mounting arrangement for this drill are illustrated in FIG. 11 and it will be seen that this drill can be mounted in substantially the same manner as the high speed drill on the top tool head. Briefly this drill can also be provided with a tapered end drill bit 412 which is directed upwardly and the drill is held by means of a clamp 414 which is attached to a motor mounting plate 416. This plate is detachably connected to a vertical rail 418 which is movably mounted in blocks 420. These blocks are connected by means of spacers to the right hand mounting plate 350. The drill can be moved vertically with respect to the mounting plate by means of air cylinder 352 which is operatively connected to the bottom end of the rail 418. Although the two power drills are shown as aligned in the vertical direction in FIG. 2A, in an alternate version of the machine, the drills are staggered so that the upper drill is a short distance closer to the front end of the machine than the lower drill.

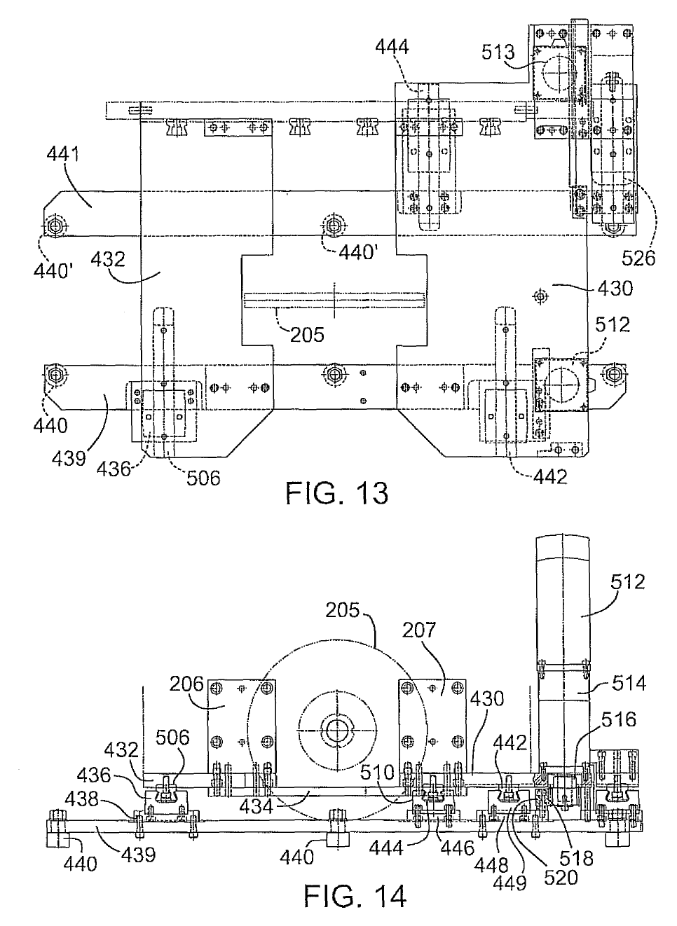

FIGS. 13 to 16 illustrate a guide assembly of the machine 10 which is part of the top tool head. FIGS. 13 and 14 show the clamping rollers 205 in chain link lines. As shown clearly in FIGS. 13 and 14, a right hand mounting plate 430 and a left hand mounting plate 432 are connected together by means of a support bar 434. The support bar 434 is attached to these two plates by means of screws and dowel pins as shown. The left hand mounting plate has a rail 506 mounted on its bottom which is slidably connected to rail engaging block 436 which is mounted by means of screws to mounting bar 438. The bar 438 is connected by screws to the top of elongate bearing support member 439 in which are mounted three cam-follower bearings or rollers 440,

Mounted to the bottom of the right hand mounting plate 430 are two short rails 442, 444 which are parallel but staggered with respect to each other. The rail 442 is embraced by sliding block 449 which is connected to block mounting bar 448. The bar 448 is connected to the bearing support member 439 by screws. There is a second bearing support system 441 spaced apart from but parallel to the support member 439. Three cam-follower bearings or rollers 440′ are distributed along and connected to the support member 441. The short rail 444 is connected to a sliding block which is connected to a mounting bar 446. The bar 446 is connected by screws to the support member 441.

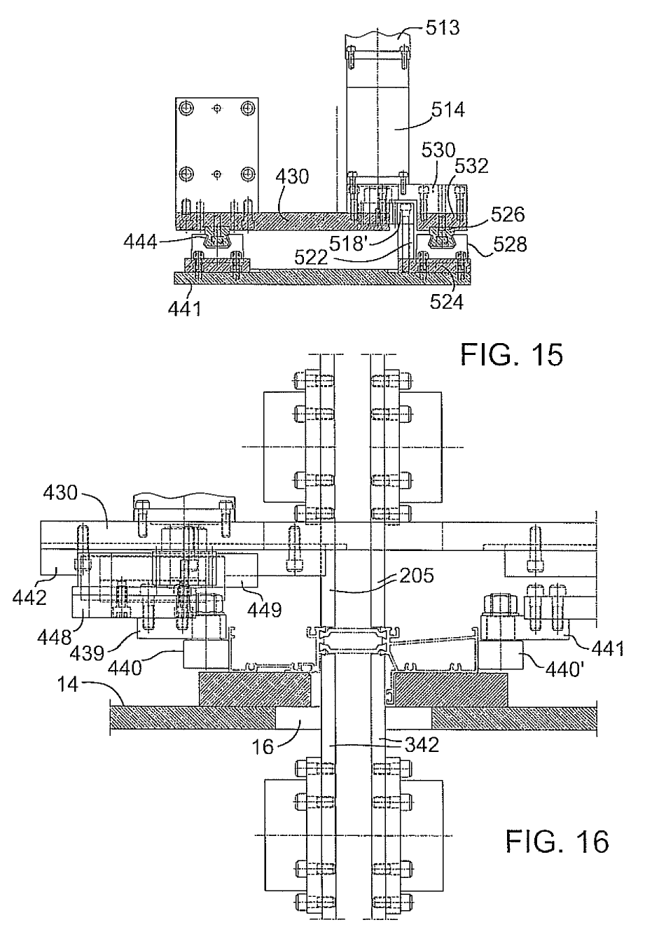

Mounted on top of the plate 430 are two further servomotors 512, 513 each connected to its own gearbox 514 by screws. One exemplary servomotor is made by Mitsubishi, Model HC KFE43KB and the gearboxes can be those made by Gearmax, Model 23GM028. The output shaft of each gearbox is connected to a spur gear 516 which engages horizontal rack 518, 518′. The rack 518 can be mounted on the bar 448 using a suitable spacer 520. It will be thus be seen that the profile support member 439 can be moved towards or away from the support member 441 by the computer control to accommodate metal profiles of different sizes and the same is true of the support member 441. The rack 518′ shown in FIG. 15 is connected by means of a spacer 522 to a block mounting bar 524 which is connected by screws to the bearing support member 441. A short horizontal rail 526 is slidably mounted in a block 528 mounted on the bar 524. The rail 526 is mounted to the bottom of a reducer mounting bracket 530 by means of a rail mounting bar 532.

An exemplary version of a computer control system that can be used to operate the above described machine uses a Mitsubishi programmable logic controller (PLC) capable of serving nine servo axes and an industrial computer for the human/machinery interface (HMI). The computer is programmed with a connection extrusion database for the operating machine. The HMI provides for auto mode, manual mode, program editor, teaching mode, and troubleshooting. In auto mode, the operator has to load the extrusions on the machine and fit the plastic strips in position for pulling between the extrusions. During an operating cycle, the control system keeps constant torque for pulling the plastic strips between the two extrusions and then rolls the extrusions after the plastic strips are pulled into position. The manual mode is mostly for maintenance needs. The teaching mode is useful to add a new extrusion or profile into the database of the computer. Each extrusion has reference to three main positions which are for the knurling position, the rolling position, and the pre-rolling position.

All of the servomotors in an exemplary embodiment of the machine are equipped with adaptive torque control. Each servomotor has a maximum torque specification for its operation and if will shut-off if the maximum is reached. With adaptive torque control however, this maximum torque can be adjusted, for example by about 20%. If this adjusted torque is reached, the servomotor will not shut off but will send a signal to the control system to facilitate operational control.

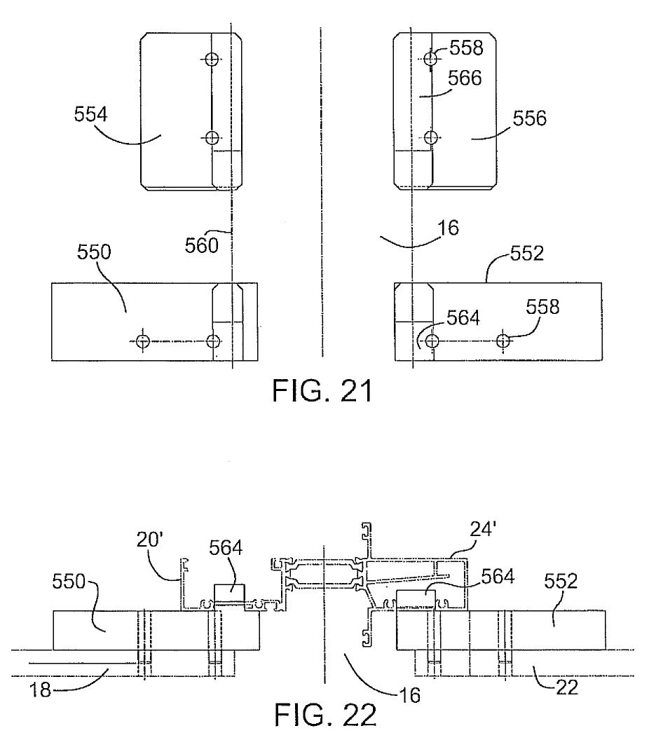

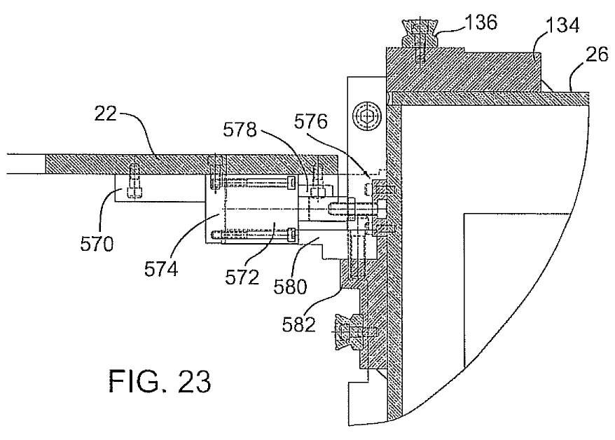

FIG. 21 illustrates two front end fixtures 550, 552 that are used on the table top to hold the front ends of two metal profiles. This Figure also illustrates two rear end fixtures 554 and 556, which are used to hold the rear ends of the two profiles. As shown, the two front end fixtures are similar in construction as are the two rear end fixtures, all of which can be made of a suitable metal such as steel, Although FIG. 21 shows the rear end fixtures fairly close to the front end fixtures, this is simply for ease of illustration and it will be understood that the rear end fixtures are spaced apart from the front end fixtures by the length of the profiles to be connected, for example by 16′, 18′, up to 24′ or more. These fixtures can be mounted in suitably sized recesses formed in the outer top section 18 and the inner top section 22 of the table top so that they can be located and positioned quickly and accurately. A number of these recesses can be formed in each top section of the table top along its length in order that profiles of different standard lengths can be accommodated. It will also be understood that the front and rear end fixtures 554 and 550 on the left side of FIG. 21, which are mounted on the outer top section, are fixed in their position. On the other hand, the front and rear end fixtures 552 and 556 can be moved inwardly or outwardly with the inner top section 22 by means of air cylinder actuators such as that illustrated in FIG. 12 and described below in connection with FIG. 23.

Formed on each of the end fixtures is an upwardly projecting tab or flange, 564, 566. Each of these tabs extends in the lengthwise direction, of the table top and is located along the inner side of the fixture. These tabs can be used to secure an end of a metal profile on the end fixture in the manner illustrated in FIG. 22. It will be appreciated that the shape and size of these end fixtures can vary and they will depend to a large extent on the metal profiles to be attached by the machine. For this reason, the end fixtures are readily detachable so that they can be replaced by other end fixtures for use with different metal profiles.

FIG. 22 illustrates the two front end fixtures 550, 552 detachably mounted to the outer top section 18 and the inner top section 22 of the support table. A first metal profile 20′ is mounted at one end on the fixture 550 while a second profile 24′ is mounted on top of the fixture 552. Two differently sized tabs 564 are shown projecting through holes or slots formed in the bottoms of these profiles. Although these end fixtures are one method of securing the ends of the profiles on the table top, it will be readily apparent that other attachment methods can be used, if desired, provided they do not interfere with the operation of the machine and the attachment of the plastic strips. For example, suitable mechanical clamps that attach to the table top could be used for this purpose.

FIG. 23 illustrated an alternate form of mounting for the inner top section 22 of the support table 12. Shown on the right side of this figure is an upper corner of the elongate support beam 26 on which is mounted the supporting bar 134. The illustrated portion of the top section 22 is mounted by screws to a rail 570. Also mounted below the top section 22 is an air cylinder actuator 572 which is mounted by screws on a cylinder mounting bracket 574. The bracket is connected at the top to the top section 22 by means of screws. The rod of the actuator is connected to a push-pull bracket 576, which is detachably connected to the side of the beam. Slidably mounted on the rail 570 is a block 578, only a portion of which can be seen in the Figure. This block is detachably connected to a horizontally extending bracket 580. If necessary, a spacer can be arranged between the block and the bracket 580. The bracket 580 is attached by a screw to the top of metal support 582 which can be welded to the side of the beam. It will be appreciated that an advantage of this type of movable support for the inner top section 22 over that shown in FIG. 12 is that it leaves the top of the top section 22 clear and unobstructed. In one embodiment of the present machine, there are 10 of the air cylinders 572 spaced along the length of the support table.

While the present invention has been illustrated and described as embodied in exemplary embodiments, it is understood that the present invention is not limited to the details shown and described herein, since it will be understood that the various omissions, modifications, substitutions and changes in the forms and details of the disclosed machine and its method of operation may be made by those skilled in the art without departing in any way from the spirit and scope of the present invention. For example, those of ordinary skill in the art will readily adapt the present disclosure for various other applications without departing from the spirit or scope of the present invention.

We claim:

1. A machine for connecting elongate metal profiles with at least one plastic strip, said machine comprising:
an elongate support table for supporting a pair of elongate metal profiles to be connected, said table forming a table top and an elongate slot extending longitudinally along said table top, said table top being divided by said slot into an inner top section for supporting an elongate first metal profile and an outer top section for supporting an elongate second metal profile so that, during use of said machine, the first and second metal profiles are horizontally spaced from one another;
a horizontal, elongate support beam extending along one side of said support table and having a top and a bottom;
means for supporting opposite ends of said support beam in an elevated position;
a support carriage mounted for horizontal movement lengthwise along the support beam;
a first drive system for moving said support carriage horizontally along said support beam firstly in a front end to rear end direction to pull at least one plastic strip between said first and second profiles and secondly in a rear end to front end direction to clamp opposite edges of said at least one plastic strip to said first and second profiles;
top and bottom tool heads each mounted on said support carriage for vertical movement thereon, the top tool head mounted above said support table and above said bottom tool head, the bottom tool head mounted below said support table;
two further drive systems for respectively moving said tool heads vertically on said support carriage;
a strip puller mechanism mounted on said tool heads for horizontal movement therewith, said strip puller mechanism being adapted to engage and hold at least one end section of said at least one plastic strip prior to and during the pulling of said at least one plastic strip between said first and second profiles; and
a pair of clamping rollers rotatably mounted on each tool head for respectively engaging and bending longitudinal connecting flanges extending along the lengths of said first and second profiles in order to connect said at least one plastic strip to these profiles.

2. The machine according to claim 1 including at least one rotatable knurling tool mounted on each tool head so as to be vertically movable on its respective tool head, wherein said machine is adapted to carry out a knurling operation on said longitudinal connecting flanges as said at least one plastic strip is pulled between the first and second profiles.

3. The machine according to claim 2 wherein the or each knurling tool has a knurling wheel made to imprint at least one connecting flange rollably engaged by the knurling wheel with knurls in a non-cutting manner.

4. The machine according to claim 1 wherein said strip pulling mechanism comprises two electrical drills each mounted on a respective one of said tool heads and two linear actuators each operatively connected to a respective one of the drills and adapted to move its respective drill vertically in order to move the drill from a disengaged, retracted position to drilling positions, whereby each drill is able to drill through the end section of a respective one of two plastic strips so that a drill bit of the drill can be used to pull said one plastic strip.

5. The machine according to claim 1 wherein each of said further drive systems for moving a respective one of the tool heads is spring loaded so as to bias the respective clamping rollers on said one tool head into engagement with the adjacent longitudinal connecting flanges of the profiles during use of the machine.

6. The machine according to claim 1 wherein each further drive system for moving a respective one of the tool heads includes at least one ball screw which extends substantially vertically and at least one servomotor for turning said at least one ball screw, and wherein the or each servomotor has its own gear box which is mounted on its respective tool head.

7. The machine according to claim 1 including two spaced-apart rotatable knurling tools mounted on each tool head so as to be vertically movable relative to their respective tool head, two vertical linear actuators mounted on each tool head for moving the two knurling tools vertically, and means mounted on each tool head for biasing each of the two knurling tools horizontally into engagement with a respective pair of the longitudinal connecting flanges, wherein the horizontal position of each knurling tool is determined by pressure between the respective knurling tool and said pair of longitudinal connecting flanges engaged thereby during a knurling operation by said machine.

8. The machine according to claim 1 including a profile guide and support assembly mounted on said top tool head, said guide assembly including two spaced-apart support members, spaced-apart roller bearings mounted on each of support members, and motor means for adjustably moving the two support members towards or away from each other, wherein said guide and support assembly allows the machine to accommodate first and second metal profiles of different sizes, these profiles during use of the machine being mounted between the two support members and engaged and supported by said roller bearings.

9. A machine for knurling and connecting elongate, first and second metal profiles, said machine comprising:
an elongate support table for supporting and holding said first and second metal profiles so that they are spaced apart from one another a predetermined distance;
a horizontal, elongate support member extending along the support table in its lengthwise direction;
a single support carriage mounted for movement along the length of the support member;
a tool head system mounted on said support carriage for vertical movement thereon;
a motor drive for moving said support carriage horizontally along said support member in said lengthwise direction;
a drive system for moving said tool head system vertically;
clamping rollers rotatably mounted on said tool head system for respectively engaging and bending longitudinal connecting flanges extending along the lengths of said first and second profiles in order to connect same by at least one plastic connecting strip inserted between the profiles; and
rotatable knurling tools mounted on said tool head system so as to be vertically movable relative to the tool head system and adapted to carry out a knurling operation on said longitudinal connecting flanges prior to the bending of said longitudinal connecting flanges by said clamping rollers.

10. The machine according to claim 9 wherein said tool head system includes top and bottom tools heads each mounted for vertical movement on said support carriage, the top tool head being mounted above said support table and the bottom tool head being mounted below said support table, and wherein two of said knurling tools are mounted on each tool head so as to be vertically movable relative to their respective tool head.

11. The machine according to claim 10 wherein each knurling tool has a knurling wheel made to imprint a respective two of said longitudinal connecting flanges by means of a rolling, non-cutting engagement.

12. The machine according to claim 10 including two vertical linear actuators mounted on each tool head for moving the two knurling tools vertically and means mounted on each tool head for biasing each of the two knurling tools horizontally into engagement with a respective pair of the longitudinal connecting flanges, wherein the horizontal position of each knurling tool is determined by pressure between the respective knurling tool and said pair of longitudinal connecting flanges engaged thereby during a knurling operation by said machine.

13. The machine according to claim 9 including an adjustable profile guide and support assembly, said guide and support assembly including two spaced-apart, elongate support members, spaced-apart roller bearings mounted on each of said support members, and actuator means for adjustably moving the two support members towards or away from each other.

14. A machine for connecting elongate first and second metal profiles with at least one plastic strip, said machine comprising:
an elongate support table arrangement for supporting and holding said first and second metal profiles in fixed, spaced-apart positions;
a support carriage system including a support carriage mounted for powered movement lengthwise along said support table arrangement;
a tool head system mounted on said support carriage for vertical movement thereon;
a linear drive system for moving said tool head system vertically;
clamping rollers rotatably mounted on said tool head system for respectively engaging and bending longitudinal connecting flanges extending along the lengths of said first and second profiles in order to connect same by clamping each longitudinal edge of each plastic strip between a respective pair of said connecting flanges; and
at least one pulling mechanism mounted on said tool head system for horizontal movement therewith, said at least one pulling mechanism including at least one power drill adapted to hold and turn a drill bit,
wherein, during use of said machine, said at least one power drill fitted with said drill bit can drill through and hold an end section of said at least one plastic strip in order to pull said at least one plastic strip between the first and second profiles.

15. The machine according to claim 14 wherein there are two of said at least one pulling mechanism, each of which has one of said at least one power drill, said tool head system includes top and bottom tool heads each mounted for vertical movement on said support carriage and mounted respectively above and below said support table arrangement, and each power drill is mounted on a respective one of said tool heads.

16. The machine according to claim 15 including a linear actuator for moving a respective one of the power drills vertically from a disengaged, retracted position to drilling positions.

17. The machine according to claim 16 wherein said support table arrangement includes a support table forming a table top and an elongate slot extending longitudinally along said table top, said table top being divided by said slot into an inner top section for supporting said first metal profile and an outer top section for supporting said second metal profile so that it is horizontally spaced from the first metal profile.

18. The machine according to claim 15 including two rotatable knurling tools mounted on each of said tool heads, each knurling tool being vertically movable on its respective tool head, wherein said machine can carry out a knurling operation on said longitudinal connecting flanges as said at least one plastic strip is pulled between the first and second metal profiles.

19. The machine according to claim 15 wherein each power drill is a high speed electric drill and each is adapted to drill through and hold the end section of a respective one of two plastic strips, whereby the two power drills and their drill bits can pull the two plastic strips simultaneously between the first and second metal profiles.

20. The machine according to claim 19 wherein including air cylinder actuators, each operatively connected to a respective one of said power drills in order to move the power drill vertically from a disengaged; retracted position to drilling positions.
